(19) United States
(12) Patent Application Publication
(10) Pub. No.: US 2007/0296928 A1
(43) Pub. Date: Dec. 27, 2007

(54) Projection type display device and method of cooling lamp unit in the same

(75) Inventors: Katsuaki Okubo, Tokyo (JP); Akimitsu Ishizuka, Tokyo (JP)

Correspondence Address: BLAKELY SOKOLOFF TAYLOR & ZAFMAN, 1279 OAKMEAD PARKWAY, SUNNYVALE, CA, 94085-4040, US

(73) Assignee: Kabushiki Kaisha Toshiba

(21) Appl. No.: 11/634,047

(22) Filed: Dec. 4, 2006

(30) Foreign Application Priority Data
Jun. 21, 2006 (JP) 2006-171947

(51) Int. Cl. G03B 21/18

(52) U.S. Cl. 353/57

(57) ABSTRACT

A projection type display device of the invention includes a lamp unit (4) having a lamp holder (44) for holding a lamp, a power source cooling fan (6) for cooling a power source unit (3), and a duct (8) through which air caused to circulate by driving of the power source cooling fan (6) is guided, and which has at least a part of a wall portion defined by the lamp holder (44), so that heat exchange is performed between the air sent out by the power source cooling fan (6) and the lamp holder (44).

The present application is based on Japanese patent application No. 2006-171947, the entire contents of which are incorporated herein by reference.

### BACKGROUND

1. Field

One embodiment of the invention relates to a projection type display device including a lamp unit and a power source unit, and a method of cooling the lamp unit in the projection type display device.

2. Description of the Related Art

Heretofore, there has been known a projection type display device in which a light emitted from a lamp is radiated to a liquid crystal panel or the like, light and shade of a light is obtained from the light thus radiated every pixel in the liquid crystal panel by performing light intensity modulation to form an optical image, and the resulting optical image is projected in an enlarged form on a screen or the like. This projection type display device, for example, is disclosed in the Japanese Patent Kokai No. 2005-31106. The projection type display device described in the Japanese Patent Kokai No. 2005-31106 is provided with a first cooling fan for cooling a power source unit, and a second cooling fan for cooling a light valve. Also, a cooling air duct of the first cooling fan, and a cooling air duct of the second cooling fan are formed independently of each other. However, in the projection type display device described in the Japanese Patent Kokai No. 2005-31106, it is necessary to provide the two fans. As a result, the number of components or parts increases, and a space efficiency within the device main body is poor.

On the other hand, a projection type display device adapted to cool a power source circuit and a light source lamp unit by using one sirocco fan has been known as one in which the problem as described above is not caused. This projection type display device, for example, is disclosed in the Japanese Patent Kokai No. 11-119181. In the projection type display device described in the Japanese Patent Kokai No. 11-119181, an air delivery pipe which branches into two parts is provided on a downstream side of the sirocco fan. Thus, air sent out from the sirocco fan is guided to be distributed to the power source unit and the light source lamp unit through the two parts into which the air delivery pipe branches, respectively.

However, in the projection type display device described in the Japanese Patent Kokai No. 11-119181, the air sent out from one sirocco fan is distributed to the power source unit side and the lamp unit side. As a result, a sufficient flow rate of the air cannot be obtained within the power source unit, and thus the efficiency of cooling the power source unit is insufficient.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary plan view showing an internal construction of a device main body of a projection type display device according to an embodiment of the invention;

FIG. 2 is an exemplary partial perspective view showing the projection type display device according to the embodiment of the invention;

FIG. 3 is an exemplary partial cross sectional view showing a flow of air caused by a power source cooling fan of the projection type display device according to the embodiment of the invention;

FIG. 4 is an exemplary perspective view showing a guiding member having a duct defining portion, and a cooling fan for a power source of the projection type display device according to the embodiment of the invention;

FIG. 5 is an exemplary perspective view showing a lamp holder of the projection type display device according to the embodiment of the invention;

FIG. 6 is an exemplary perspective view showing another lamp holder of the projection type display device according to the embodiment of the present invention;

FIG. 7 is an exemplary partial cross sectional view showing a flow of air sent out by the power source cooling fan of the projection type display device according to the embodiment of the invention;

FIG. 8 is an exemplary exploded perspective view showing a lamp ballast of the projection type display device according to the embodiment of the invention; and

FIG. 9 is an exemplary partial cross sectional view showing a flow of air caused by a ballast cooling fan of the projection type display device according to the embodiment of the invention.

### DETAILED DESCRIPTION OF PREFERRED EMBODIMENTS

Various embodiments according to the invention will be described hereinafter with reference to the accompanying drawings. In general, according to one embodiment of the invention, there is provided a projection type display device, including:

a lamp unit having a lamp holder for holding a lamp;

a power source unit for supplying a power to each of internal constituent elements;

a duct defined on an outside surface of the lamp holder of the lamp unit; and

a common cooling fan for supplying a cooling medium to each of the power source unit and the lamp unit.

In addition, according to one embodiment of the invention, there is provided a projection type display device, including:

a lamp unit having a lamp holder for holding a lamp, a cooling hole through which a cooling medium is caused to circulate in order to cool the lamp being formed in the lamp holder;

a power source unit for supplying a power to each of internal constituent elements;

a duct defined on an outside surface of the lamp holder of the lamp unit to communicate with the cooling hole; and

a common cooling fan for supplying the cooling medium to each of the power source unit and the duct of the lamp unit.

According to the projection type display device of the invention, when the cooling fan is driven, the power source unit is cooled and the air is caused to circulate in the duct. Also, since the duct is defined on the outside surface of the lamp holder, the heat exchange is performed between the air being caused to circulate in the duct and the lamp holder, whereby the circulating air takes the heat away from the lamp holder. As a result, it is possible to obtain the operation for cooling the ambient atmosphere or the like of the lamp held by the lamp holder, and the lamp holder as well as the cooling of the lamp holder.

In addition, it is unnecessary to distribute the air sent out from the cooling fan to the power source unit and the lamp unit. As a result, the flow rate of the air caused to flow into the power source unit through the distribution is prevented from being reduced as in conventional device, and thus one cooling fan can sufficiently cool the power source unit.

In addition, according to one embodiment of the invention, there is provided a method of cooling a lamp unit, including the steps of:

supplying a cooling medium to a power source unit disposed in a projection type display device; and

supplying the cooling medium passed through the power source unit to an outside surface of a lamp holder disposed in the projection type display device.

According to the invention, the efficiency enough to cool the power source unit can be ensured without increasing the number of components or parts such as the cooling fan, and thus the lamp unit can be exactly cooled.

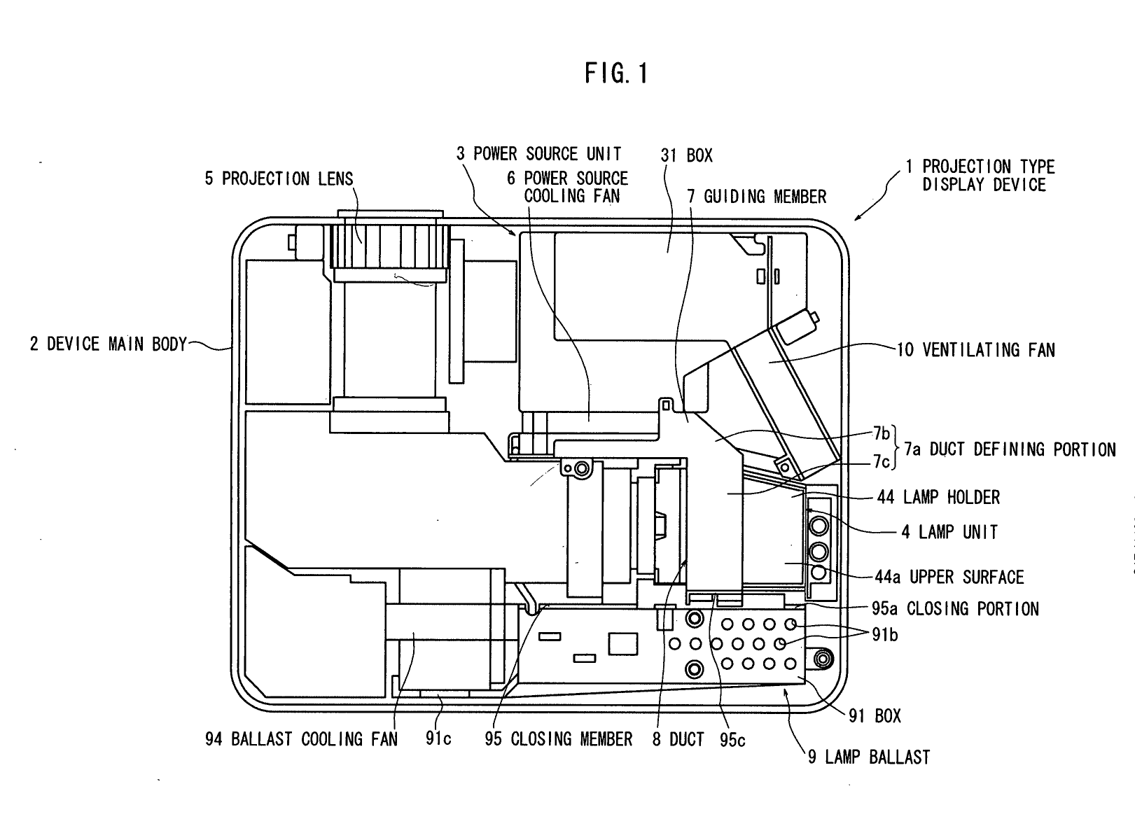

FIGS. 1 to 9 show a projection type display device according to an embodiment of the invention, and FIG. 1 is a schematic plan view explaining constituent elements disposed in a device main body of the projection type display device of the embodiment of the invention.

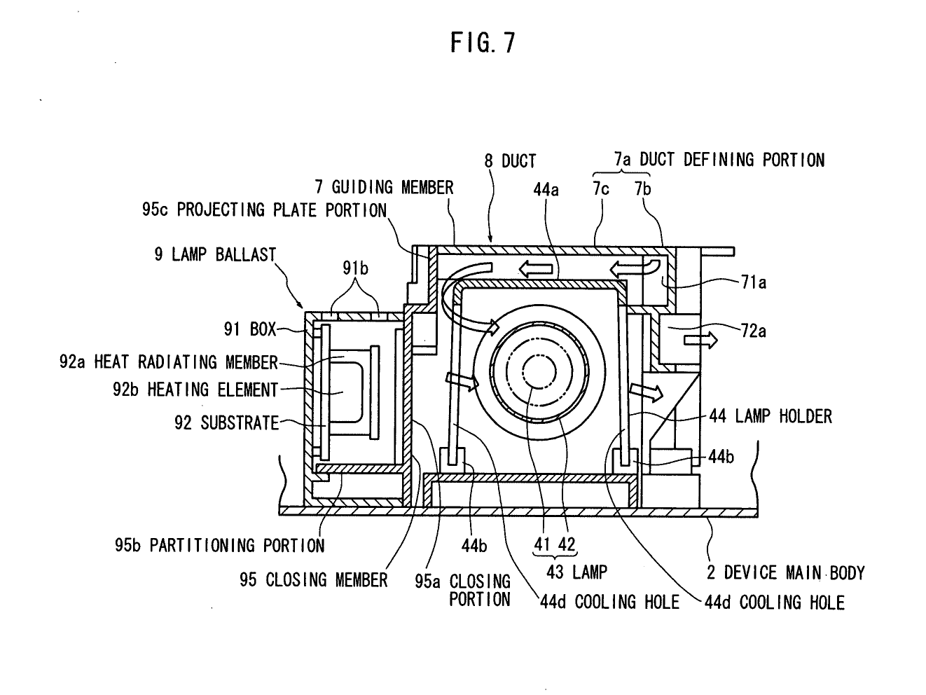

As shown in FIG. 1, a projection type display device 1 includes a chassis-shaped device main body 2, and a power source unit 3 and a lamp unit 4 which are disposed inside the device main body 2. The power source unit 3 supplies a power to each of the corresponding internal constituent elements, and its substrate (not shown) is accommodated in a box 31. The lamp unit 4 has a lamp 43 including a light-emitting tube 41 (refer to FIG. 7) and a reflector 42 (refer to FIG. 7), and a lamp holder 44 for holding the lamp 43.

A light emitted from the light-emitting tube 41 is condensed by the reflector 42 and unnecessary radiations such as an infrared radiation and an ultraviolet radiation are filter by a filter. After this, the resulting light is spectrally diffracted into an R light, a G light and a B light by a condenser lens, a reflecting mirror, a dichroic mirror and the like. After the resulting R light, G light and B light obtained through the spectral diffraction penetrate through a liquid crystal panel for R, a liquid crystal panel for G, and a liquid crystal panel for B, respectively, they are optically multiplexed by a dichroic prism and the like, and the resulting image light obtained through the optical multiplexing is projected on a screen or the like by a projection lens 5.

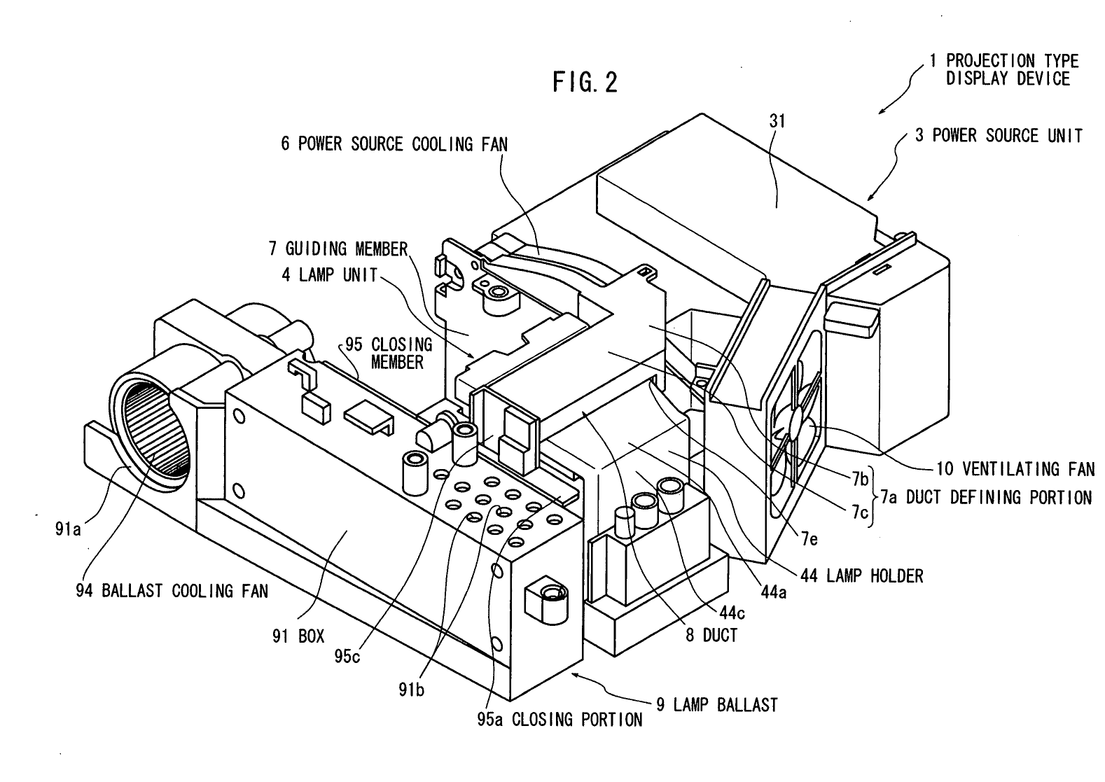

FIG. 2 is a partial perspective view showing the projection type display device according to the embodiment of the invention.

As shown in FIG. 2, the projection type display device 1 includes a power source cooling fan 6 for cooling the power source unit 3, and a guiding member 7 connected to the power source cooling fan 6 for guiding air to the lamp unit 4 and the like. Also, a duct defining portion 7a of the guiding member 7, and an upper surface 44a of the lamp holder 44 define a duct 8 for guiding the air which is circulated when the power source cooling fan 6 is driven. That is to say, the duct 8 is defined on the outside surface of the lamp holder 44. In addition, the power source cooling fan 6 supplies the air as a cooling medium to each of the power source unit 3 and the lamp unit 4.

As shown in FIG. 1, in this embodiment, the power source unit 3 is installed in a corresponding corner portion of the device main body 2, and the power source cooling fan 6 is disposed more inside than the power source unit 3 is disposed. The power source cooling fan 6 is a sirocco fan and is disposed between the power source unit 3 and the duct 8.

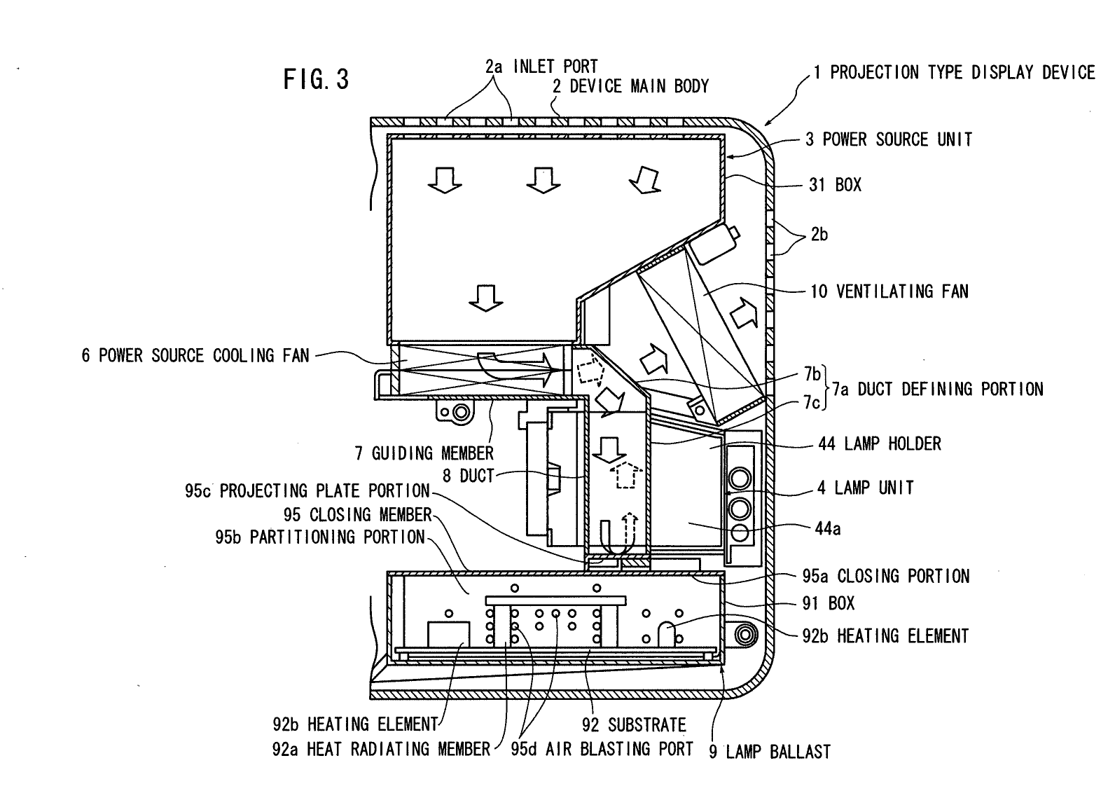

FIG. 3 is a partial transverse explanatory sectional view, of the projection type display device, showing a flow of the air caused by the power source cooling fan.

As shown in FIG. 3, when the power source cooling fan 6 is driven, the air is caused to flow into the box 31 of the power source unit 3 through inlet ports 2a formed in the device main body 2 in the vicinity of the power source unit 3. After this, a part of the air which is thermally exchanged for heating elements, etc. disposed in the box 31 is circulated via the power source cooling fan 6 into the backword of the duct 8, and then is moved into the forword of the lamp holder 44. After the air caused to flow out from the lamp holder 44 meets the remainder of the air the heat exchange for which has been performed with each of the heating elements or the like disposed in the box 31, the resulting air is discharged to the outside of the projection type display device 1 through exhaust ports 2b of the device main body 2 by a ventilating fan 10.

Although the air passed through the power source unit 3 is higher in temperature than the ambient atmosphere due to the heat exchange, it has an enough low temperature for each of the lamp holder 44 and the lamp 43, and thus the cooling effect is obtained.

Specifically, the power source cooling fan 6 rotates with a direction of inflow of the air from the power source unit 3 (a longitudinal direction in FIG. 1) as an axis, and absorbs axially the air within the power source unit 3 and sends radially the air thus absorbed. In this embodiment, the air is sent out in a direction (in a right-hand direction in FIG. 1) along the box 31 of the power source unit 3.

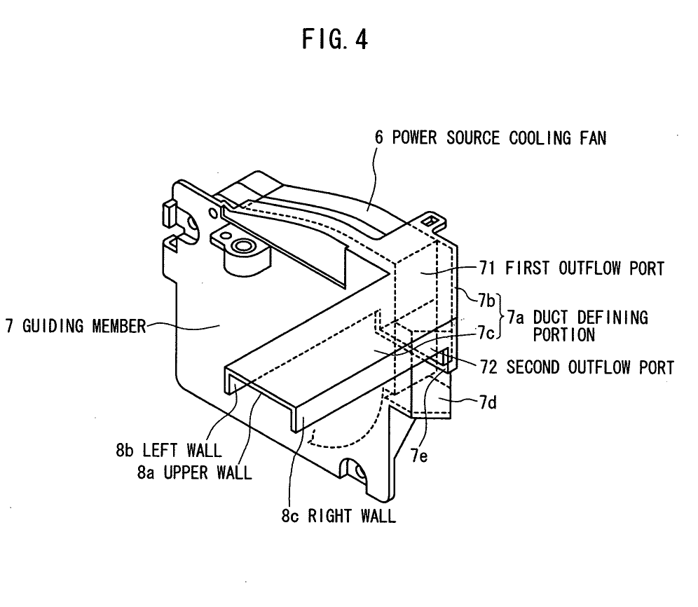

FIG. 4 is a perspective view showing an exterior appearance of the guiding member having the duct defining portion, and the power source cooling fan.

As shown in FIG. 4, the guiding member 7 is mounted to an outer hull member of the power source cooling fan 6, and defines, together with the outer hull member of the power source cooling fan 6, a first outflow port 71 through which the air is caused to flow out to the duct 8, and a second outflow port 72 through which the air is caused to flow out to the exhaust ports 2b formed in the device main body 2. Specifically, the guiding member 7 divides the air outflow port formed in the outer hull member of the power source cooling fan 6 into upper and lower parts. In this embodiment, a flow division ratio of the air outflow through the first outflow port 71 to the air outflow through the second outflow port 72 is set nearly as 1:1.

FIG. 4 also shows an exterior appearance of the guiding member. The guiding member 7 is made of a plastic material containing therein glass, and is excellent in heat resistance and heat conduction property.

The duct defining portion 7a of the guiding member 7 has a bending section 7b which is formed continuously with the first outflow port 71 and which bends right backward, and an extension section 7c which straight extends backward from the bending section 7b. The duct defining portion 7a is formed with its lower surface being released so as to form an upper wall 8a, a left wall 8b and a right wall 8c of the duct 8. In this embodiment, the duct defining portion 7a is disposed slightly apart from an upper surface 44a of the lamp holder 44, so that the air slightly flows out through the duct 8. Here, a lower side of the extension section 7c on the bending section 7b side is formed in the form of a stepped portion 7e when viewed from the side face. The stepped portion 7e abuts against a corresponding corner portion of the lamp holder 44, thereby positioning the guiding member 7 and the lamp holder 44 in place. In addition, the guiding member 7 has a plate portion 7d which is formed continuously with the right wall 8c of the extension section 7c, and which guides the air flowed out through the first outflow port 72 to the exhaust port 2b.

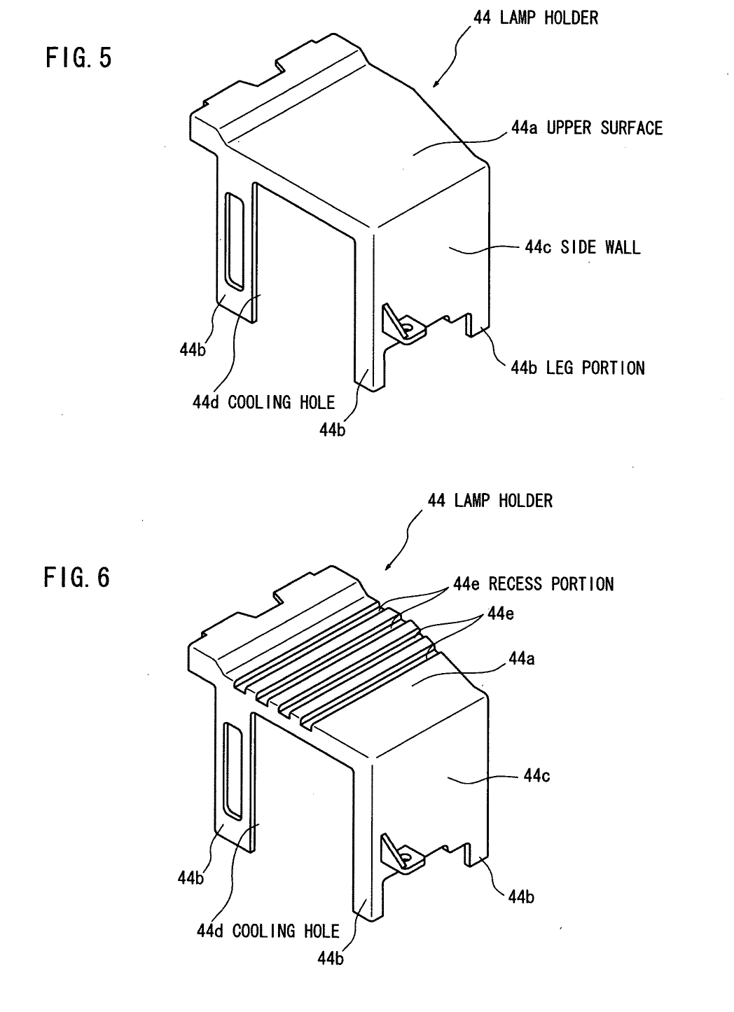

FIG. 5 is a perspective view showing an exterior appearance of the lamp holder 44. The lamp holder 44 is made of a plastic material containing therein glass, and is excellent in heat resistance and heat conduction property.

As shown in FIG. 5, the lamp holder 44 has an upper surface 44a which is formed nearly in rectangular shape when viewed from the plane, a side wall 44c integral with the upper surface 44a, and four leg portions 44b which extends downward from respective corner portions of the upper surface 44a. In this embodiment, the lamp holder 44 has a right surface 44e formed thereon, and the left side thereof is nearly closed by the lamp 43 during assembling of the lamp 43. Hence, a circulation path of the air is defined inside the lamp holder 44 in the longitudinal direction. Cooling holes 44d through which the air is caused to circulate are formed in the front surface and the back surface of the lamp holder 44, respectively. The backward cooling hole 44d is a cooling hole through which the air circulated in the duct 8 is guided to the inside of the lamp holder 44.

In addition, the embodiment described above has shown that the upper surface 44a of the lamp holder 44, as shown in FIG. 5, is formed to be nearly flat. Instead, as shown in FIG. 6, for example, recess portions 44e may be formed on the upper surface 44a of the lamp holder 44 to obtain the fin-shaped upper surface 44a, thereby increasing a surface area of the upper surface 44a which contacts the circulating air. As a result, it is possible to enhance the efficiency of the heat exchange between the circulating air and the lamp holder 44. In addition, even when convex portions are formed instead of the recess portions 44e, it is possible to obtain the same effect as that in the case of the construction having the recess portions 44e.

In addition, as shown in FIG. 1, a lamp ballast 9 for the lamp 43 is disposed in the rear of the lamp unit 4. The lamp ballast 9 supplies a power to the lamp 43, and its substrate 92 (refer to FIG. 3) is accommodated in the box 91. In this embodiment, the lamp ballast 9 is disposed in a right backward corner portion of the device main body 2.

FIG. 7 is a partial longitudinal explanatory sectional view, of the projection type display device, showing a flow of the air sent out from the power source cooling fan.

As shown in FIG. 7, the lamp holder 44 and the lamp ballast 9 are disposed apart from each other, and the duct defining portion 7a of the guiding member 7 is formed so as to project backward with respect to the lamp holder 44. As a result, the air which has been caused to circulate in the duct 8 changes its flow direction to a downward direction from a surface of a projecting plate portion 95c of the lamp ballast 9 and flows into the lamp holder 44 through a gap defined between the lamp holder 44 and the lamp ballast 9, and the air cooling hole 44d.

After the air flowed into the lamp holder 44 flows out in front of the lamp holder 44 via the surface of the reflector 42 within the lamp holder 44, it meets the air flowed out from the second outflow port 72 described above and flows out to the outside of the projection type display device 1 through the exhaust ports 2b formed in the right wall of the device main body 2. In this embodiment, an exhaust fan 10 is provided on this side of the exhaust ports 2b, and the air is discharged to the outside of the projection type display device 1 with the assistance of the exhaust fan 10.

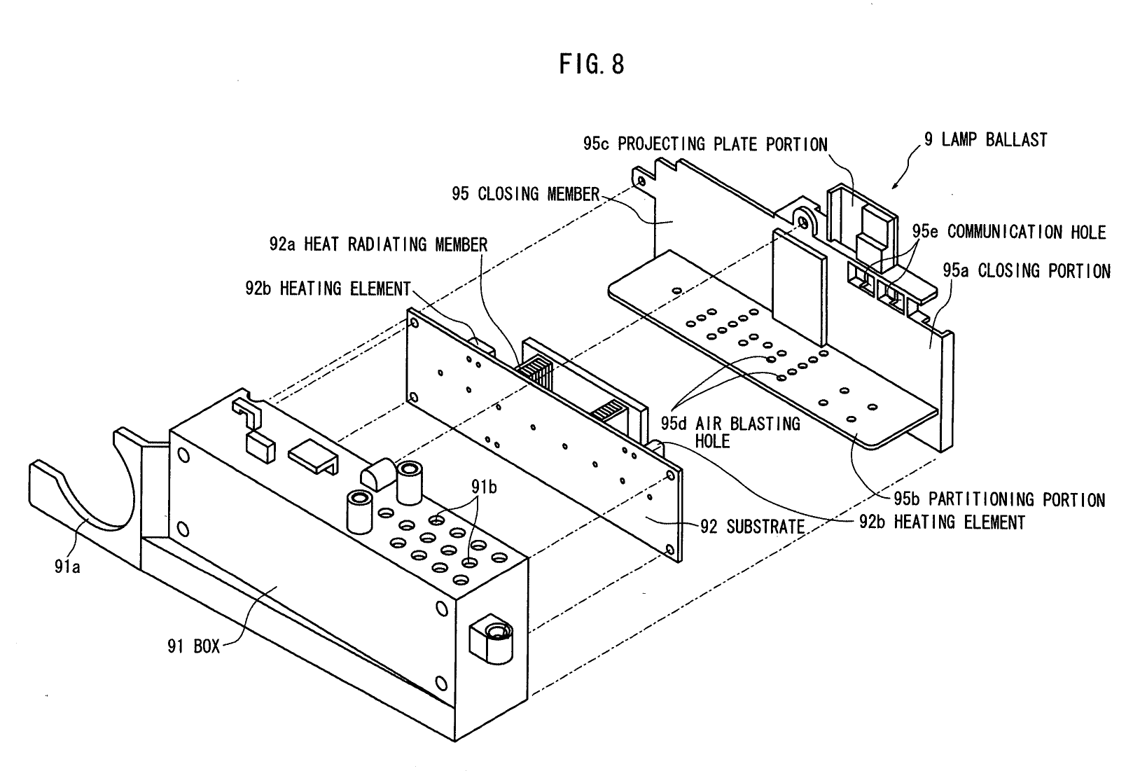

FIG. 8 is an exploded perspective view of the lamp ballast.

As shown in FIG. 8, a connection portion 91a to which the ballast cooling fan 94 is connected is connected to a left-hand side of the box 91 of the lamp ballast 9, so that each of elements mounted to the substrate 92 provided inside the box 91 is cooled. Here, the substrate 92 is fixed to the rear surface of the box 91 with vises or the like, and a plurality of heating elements 92b are mounted to a mounting surface of the substrate 92. In this embodiment, one of the heating elements 92b is a heat radiating member 92a having a fin-like shape.

In addition, the lamp unit 4 side (front side) of the box 91 is opened, and this opening is closed by a closing member 95. The ballast cooling fan 94 is a sirocco fan and sends the air to the lower side of the box 91. The closing member 95 includes a closing portion 95a for closing the front of the box 91, and a plate-like partitioning portion 95b for partitioning the inside of the box 91 into upper and lower parts. A projecting plate portion 95c which projects upward is formed in the closing portion 95a. In this embodiment, the box 91 is lower in height than the duct 8, so that the rear end of the duct 8 is closed by the projecting plate portion 95c.

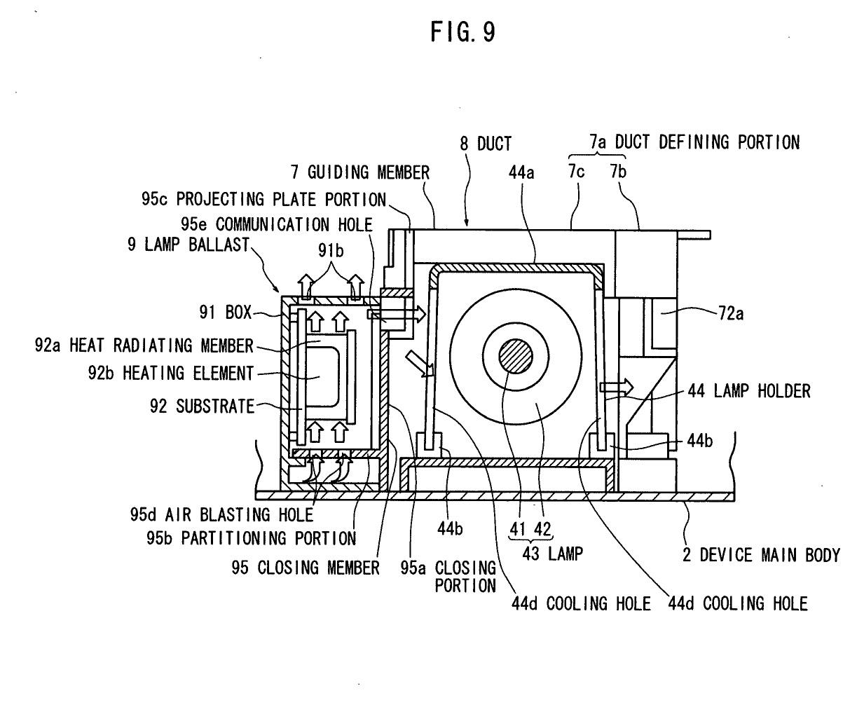

FIG. 9 is a partial transverse explanatory sectional view, of the projection type display device, showing a flow of the air caused by the ballast cooling fan.

The air sent out from the ballast cooling fan 94 is caused to circulate in a right-hand direction in a lower side of the partitioning portion 95b. A plurality of air blasting holes 95d are formed in the partitioning portion 95b, and the air enters the upper side of the partitioning portion 95b through the individual air blasting holes 95d. Here, the air blasting holes 95d are formed so as to overlap in position the heating elements 92b, respectively, when viewed from the upper surface. Thus, the air entered the upper side of the partitioning portion 95b is brown to the individual heating elements 92b.

A plurality of exhaust holes 91b through which the air in the upper side of the partitioning portion 95b in the box 91 is discharged are formed in the upper surface of the box 91. Moreover, communication holes 95e through which the upper side of the partitioning portion 95b in the box 91 communicates with the lamp unit 4 side are formed in the closing portion 95a. The air which has taken the heat away from each of the heating elements 92a is discharged to the outside of the lamp ballast 9 through the exhaust ports 91b and the communication holes 95e.

Specifically, the two communication holes 95e are provided in parallel on the left-hand and right-hand sides, respectively, and are formed so as to overlap in position the light-emitting tube 41 of the lamp 43 when viewed from the front. As a result, the air which has flowed out through the communication holes 95e performs the heat exchange with the light-emitting tube 41.

In the projection'type display device 1 constructed in the manner as described above, when the power source cooling fan 6 is driven, the power source unit 3 is cooled and the air is caused to circulate in the duct 8. Also, since the lower surface of the duct 8 is defined by the lamp holder 44, when the air is caused to circulate in the duct 8, the heat exchange is performed between the circulating air and the lamp holder 44 so that the circulating air takes the heat away from the lamp holder 44. As a result, it is possible to obtain the operation for cooling the ambient atmosphere or the like of the lamp 43 held by the lamp holder 44, and the lamp holder 44 as well as the cooling for the lamp holder 44. In addition, since the duct defining portion 7a is disposed slightly apart from the upper surface 44a of the lamp holder 44, the ambient atmosphere is cooled by the air as well which slightly flows out through the duct 8.

In addition, in this embodiment, the air which is caused to circulate in the lamp unit 4 is turned up, so that the lamp holder 44 is cooled and the reflector 42 of the lamp 43 is also cooled. Therefore, the extremely satisfactory efficient of the heat exchange is obtained.

In addition, the air circulated by the power source cooling fan 6 is not divided into the power source unit 3 and the lamp unit 4, so that the air-sending ability of the power source cooling fan 6 can be displayed to the maximum extent. Also, since the air is distributed to the first outflow port 71 and the second outflow port 72 by the guiding member 7, only a quantity of air required to cool the lamp unit 4 can be caused to circulate to the duct 8 side. As a result, the lamp unit 4 can be prevented from being overcooled. Therefore, the quantity of air caused to circulate in the power source unit 3 due to the distribution can be prevented from being reduced as in the conventional device. Also, the necessary air quantity can be sent out to the lamp unit 4, and thus the power source unit 3 and the lamp unit 4 can be exactly cooled by one power source cooling fan 6.

Note that, although the embodiment described above has shown that the air caused to flow out to the lamp unit 4 side is distributed, it is to be understood that the entire air may also be caused to flow out to the lamp unit 4 side.

In addition, the embodiment described above has shown that the circulating air is turned up forward and backward once in the lamp unit 4. However, the circulating air may also be turned up plural times to increase the circulation path of the air. In this case as well, the efficiency of the heat exchange is enhanced.

In addition, the embodiment described above has shown the duct 8 which is defined to have the rectangular shape in cross section. However, it is to be understood that the duct 8 may also be defined to have a round shape or the like in cross section. Moreover, it is to be understood that the construction relating to whether or not the exhaust fan 10 is provided, and the shape, material, etc. of the lamp holder 44 are also arbitrarily determined, and other concrete constructions or the like of the details can also be suitably changed.

It should be noted that the present invention is not limited to the embodiments described above, and the various combinations and changes may be made without departing from or changing the technical idea of the present invention.

What is claimed is:

1. A projection type display device, comprising:
a lamp unit having a lamp holder for holding a lamp;
a power source unit for supplying a power to each of internal constituent elements;
a duct defined on an outside surface of the lamp holder of the lamp unit; and
a common cooling fan for supplying a cooling medium to each of the power source unit and the lamp unit.

2. A projection type display device according to claim 1, wherein the lamp holder has a cooling hole through which the cooling medium caused to circulate in the duct is guided to an inside of the lamp holder.

3. A projection type display device according to claim 1, wherein the cooling fan is provided between the power source unit and the duct, and sends out the cooling medium caused to circulate in the power source unit toward the duct.

4. A projection type display device according to claim 1, wherein the duct has a distribution mechanism for causing a part of the cooling medium caused to circulate in the power source unit to circulate in the duct, and causing the remainder of the cooling medium to circulate into an outside portion of the duct.

5. A projection type display device according to claim 3, wherein the duct has a distribution mechanism for causing a part of the cooling medium caused to circulate in the power source unit to circulate in the duct, and causing the remainder of the cooling medium to circulate into an outside portion of the duct.

6. A projection type display device according to claim 1, wherein the lamp holder has a plurality of recess portions which are formed on an outside surface, of the lamp holder, having the duct defined therein.

7. A projection type display device according to claim 2, wherein the lamp holder has a plurality of recess portions which are formed on an outside surface, of the lamp holder, having the duct defined therein.

8. A projection type display device, comprising:
a lamp unit having a lamp holder for holding a lamp, the lamp holder having a cooling hole through which a cooling medium is caused to circulate in order to cool the lamp provided in the lamp holder;
a power source unit for supplying a power to each of internal constituent elements;
a duct defined on an outside surface of the lamp holder of the lamp unit to communicate with the cooling hole; and
a common cooling fan for supplying the cooling medium to each of the power source unit and the duct of the lamp unit.

9. A projection type display device according to claim 8, wherein the cooling fan is provided between the power source unit and the duct, and sends out the cooling medium caused to circulate in the power source unit toward the duct.

10. A projection type display device according to claim 8, wherein the duct has a distribution mechanism for causing a part of the cooling medium caused to circulate in the power source unit to circulate in the duct, and causing the remainder of the cooling medium to circulate into an outside portion of the duct.

11. A projection type display device according to claim 9, wherein the duct has a distribution mechanism for causing a part of the cooling medium caused to circulate in the power source unit to circulate in the duct, and causing the remainder of the cooling medium to circulate into an outside portion of the duct.

12. A projection type display device according to claim 8, wherein the lamp holder has a plurality of recess portions which are formed on an outside surface, of the lamp holder, having the duct defined therein.

13. A projection type display device according to claim 8, wherein the duct forms a path through which the cooling medium turned up plural times is caused to circulate in the duct and the lamp holder.

14. A method of cooling a lamp unit, comprising the steps of:
supplying a cooling medium to a power source unit disposed in a projection type display device; and
supplying the cooling medium passed through the power source unit to an outside surface of a lamp holder disposed in the projection type display device.

15. A method of cooling a lamp unit according to claim 14, wherein the cooling medium supplied to the outside surface of the lamp holder is guided to a cooling hole formed in the lamp holder and cools the lamp held in the lamp holder.

16. A method of cooling a lamp unit according to claim 14, further comprising the steps of:
installing a cooling fan between the power source unit and the lamp holder; and
sending out the cooling medium passed through the power source unit toward the outside surface of the lamp holder by the cooling fan.

17. A method of cooling a lamp unit according to claim 14, wherein a part of the cooling medium caused to circulate in the power source unit is supplied to the lamp holder, and the remainder of the cooling medium is supplied to an outside portion of the lamp holder.

18. A method of cooling a lamp unit according to claim 14, wherein a plurality of recess portions are formed on the outside surface of the lamp holder, in which the cooling medium is circulated to cool the lamp holder.

19. A method of cooling a lamp unit according to claim 15, wherein a part of the cooling medium caused to circulate in the power source unit is supplied to the lamp holder, and the remainder of the cooling medium is supplied to an outside portion of the lamp holder.

20. A method of cooling a lamp unit according to claim 15, wherein a plurality of recess portions are formed on the outside surface of the lamp holder, in which the cooling medium is circulated to cool the lamp holder.
